(19) United States
(12) Patent Application Publication
(10) Pub. No.: US 2012/0233373 A1
(43) Pub. Date: Sep. 13, 2012

(54) ELECTRONIC EQUIPMENT SYSTEM, ELECTRONIC EQUIPMENT AND CONNECTION EQUIPMENT

(75) Inventor: Kei OHASHI, Osaka (JP)

(73) Assignee: SHARP KABUSHIKI KAISHA, Osaka (JP)

(21) Appl. No.: 13/413,716

(22) Filed: Mar. 7, 2012

(30) Foreign Application Priority Data
Mar. 11, 2011 (JP) 2011-054580

(51) Int. Cl. G06F 13/42

(52) U.S. Cl. 710/313

(57) ABSTRACT

A branching device (connection equipment) 2 for connection to electronic equipment 1 divides signal lines used for USB 3.0 (first interface) into signal lines used for USB 2.0 (second interface) and signal lines not used for USB 2.0. The branching device 2 can be connected to a connection device 4 performing communication in accordance with USB 2.0 and to a connection device 3 performing communication using the signal lines not used for USB 2.0. The electronic equipment 1 inputs/outputs data, through the branching unit 2, to/from the connection device 4 in accordance with USB 2.0 and to/from the connection device 3 by communication using the signal lines not used for USB 2.0. The two types of data input/output can be executed in parallel.

### CROSS-REFERENCE TO RELATED APPLICATIONS

This Nonprovisional application claims priority under 35 U.S.C. §119(a) on Patent Application No. 2011-54580 filed in Japan on Mar. 11, 2011, the entire contents of which are hereby incorporated by reference.

### BACKGROUND

1. Technical Field

The present invention relates to an electronic equipment system including electronic equipment and connection equipment for connection to the electronic equipment, and also relates to the electronic equipment and the connection equipment.

2. Description of Related Art

Electronic equipment such as a notebook PC (Personal Computer) is often provided with a connection interface for connecting another device such as a mouse or hard disk drive to the electronic equipment. By connecting the device with electric equipment, the electric equipment can input/output data to/from the device and can use the function of the device. An example of such a connection interface includes a USB (Universal Serial Bus). Japanese Utility-Model Registration No. 3151486 discloses USB 3.0 as an example of the connection interface.

USB 3.0 a connection interface having backward compatibility with USB 2.0 and using a larger number of signal lines compared to USB 2.0 to enable faster communication. USB 3.0 uses five more lines in addition to the signal lines used in USB 2.0. The additional five lines include four differential pairs for high-speed data communication and one ground line. The electronic equipment using USB 3.0 has a signal processing capability to execute signal processing for USB 3.0 which is faster than USB 2.0. When a device compliant with USB 3.0 is connected to the connector of USB 3.0, communication is performed using signal lines including five signal lines added for USB 3.0. When a device not compliant with USB 3.0 but compliant with USB 2.0 is connected to the connector of USB 3.0, the communication is performed in accordance with USB 2.0, not using the five signal lines added for USB 3.0.

### SUMMARY OF THE INVENTION

As described above, when the device not compliant with USB 3.0 is connected to the connector of USB 3.0, the signal lines added for USB 3.0 are not used while faster signal processing compared to USB 2.0 is not executed. Moreover, many of the devices that are noncompliant with USB 3.0 but are compliant with USB 2.0, such as a mouse and a keyboard, do not require faster communication and are constantly connected to electronic equipment. In the state where such devices are connected to electronic equipment, the signal lines added for USB 3.0 are not used and also the high ability of signal processing for USB 3.0 is not utilized and thus wasted.

The present invention has been made in view of the above circumstances. An object of the invention is to provide an electronic equipment system, electronic equipment and connection equipment that use signal lines, which are not used in the state where one device is connected, to be connectable to another device, in order to effectively make use of the signal processing capability in the electronic equipment.

An electronic equipment system according to the present invention includes electronic equipment and connection equipment for connection to the electronic equipment. The electronic equipment includes a first connector compliant with a first interface for inputting/outputting data through a plurality of signal lines including signal lines used for a second interface for inputting/outputting data, and the connection equipment includes: a second connector for connection to the first connector; a third connector connected to the second connector by signal lines used for the second interface among the plurality of signal lines used for the first interface, but not connected to the second connector by signal lines not used for the second interface; and a fourth connector not connected to the second connector by the signal lines used for the second interface among the plurality of signal lines used for the first interface, but connected to the second connector by the signal lines not used for the second interface.

In the electronic equipment system according to the present invention, the connection equipment relays input/output of data between a device compliant with the second interface and the electronic equipment through signal lines connected to the third connector when the second connector is connected to the first connector and the device is connected to the third connector, and relays input/output of data between a device and the electronic equipment through signal lines connected to the fourth connector when the second connector is connected to the first connector and the device is connected to the fourth connector.

In the electronic equipment system according to the present invention, the electronic equipment further includes: a first input/output unit for inputting/outputting data in accordance with the second interface through the first connecter in a state where the connection equipment is connected to the first connector; a second input/output unit for inputting/outputting data through the first connector by signal lines not used for the second interface, not by the signal lines used for the second interface among the plurality of signal lines used for the first interface in a state where the connection equipment is connected to the first connector; and a third input/output unit for inputting/outputting data in accordance with the first interface through the first connector when a device compliant with the first interface is connected to the first connector.

Electronic equipment according to the present invention includes: a first connector compliant with the first interface for inputting/outputting data through a plurality of signal lines including signal lines used for the second interface for inputting/outputting data; a first input/output unit for inputting/outputting data in accordance with the second interface through the first connector; a second input/output unit for inputting/outputting data through the first connector by signal lines not used for the second interface, not by signal lines used for the second interface among the plurality of signal lines used for the first interface; and a third input/output unit for inputting/outputting data compliant with the first interface through the first connector.

Electronic equipment according to the present invention includes: a fifth connector compliant with the second interface for inputting/outputting data through signal lines; a fourth input/output unit for inputting/outputting data in accordance with the second interface through the fifth connector; a sixth connector not connected to signal lines used for the second interface among a plurality of signal lines used for the first interface for inputting/outputting data through the plurality of signal lines including signal lines used for the second interface, but connected to signal lines not used for the second interface; and a fifth input/output unit for inputting/outputting data by the signal lines through the sixth connector.

Connection equipment according to the present invention, which is used for connection to an electronic equipment includes: a second connector for connection to a first connector of an electronic equipment compliant with the first interface for inputting/outputting data through a plurality of signal lines including signal lines used for the second interface for inputting/outputting data through signal lines; a third connector connected to the second connector by signal lines used for the second interface among the plurality of signal lines used for the first interface, but not connected to the second connector by signal lines not used for the second interface; and a fourth connector not connected to the second connector by the signal lines used for the second interface, but connected to the second connector by the signal lines not used for the second interface among the plurality of signal lines used for the first interface.

According to an aspect of the invention, the electronic equipment includes the first connector compliant with the first interface compatible with the second interface. The connection equipment connected to the first connector of the electronic equipment divides the signal lines used for the first interface into signal lines used for the second interface and signal lines not used for the second interface. In the connection equipment, the third connector is connected to the signal lines used for the second interface, while the fourth connector is connected to the signal lines not used for the second interface.

According to another aspect of the invention, in the state where the connection equipment is connected to the electronic equipment and the device is connected to the third connector of the connection equipment, data is input or output between the electronic equipment and the device in accordance with the second interface. Moreover, in the state where the connection equipment is connected to the electronic equipment and the device is connected to the fourth connector of the connection equipment, data is input or output between the electronic equipment and the device through the signal lines not used for the second interface. Furthermore, in the state where the device corresponding to the first interface is connected to the electronic equipment, data is input or output between the electronic equipment and the device in accordance with the first interface.

According to a further aspect of the invention, the device performing communication using the signal lines not used for the second interface is connected to the fourth connector of the connection equipment, to input or output data to/from the electronic equipment through the signal lines not used for the second interface.

According to another aspect of the invention, the electronic equipment is connected with the connection equipment by a connector compatible with USB 3.0, to input/output data in accordance with USB 2.0 and to input/output data using the signal lines not used for USB 2.0 among the signal lines used for USB 3.0 through the connection equipment.

According to another aspect of the invention, the electronic equipment can execute, via the connection equipment, input/output of data by the second interface as well as input/output of data through the signal lines not used for the second interface in parallel. The electronic equipment can, for example, sufficiently make use of its high signal processing capability by inputting/outputting data to/from another device even when it is connected to the device which performs data input/output in accordance with the second interface, presenting a beneficial effect of the invention.

The above and further objects and features of the invention will more fully be apparent from the following detailed description with accompanying drawings.

### BRIEF DESCRIPTION OF THE SEVERAL VIEWS OF THE DRAWINGS

FIG. 1 is a conceptual view illustrating the appearance of the electronic equipment system according to Embodiment 1;

FIG. 2 is a block diagram illustrating the internal functional configuration of each of the equipment included in the electronic equipment system according to Embodiment 1;

FIG. 3 is a block diagram illustrating the state where electronic equipment inputs/outputs data in accordance with USB 2.0;

FIG. 4 is a block diagram illustrating the state where the electronic equipment inputs/outputs data using signal lines not used for USB 2.0;

FIG. 5 is a block diagram illustrating the state where the electronic equipment inputs/outputs data in accordance with USB 3.0;

FIG. 6 is a flowchart illustrating a procedure of the processing executed by the electronic equipment when data is input/output via a USB 3.0 socket;

FIG. 7 is a block diagram illustrating the internal functional configuration of each of the equipment included in the electronic equipment system according to Embodiment 2; and

FIG. 8 is a block diagram illustrating the internal functional configuration of each of the equipment included in the electronic equipment system according to Embodiment 3.

### DETAILED DESCRIPTION

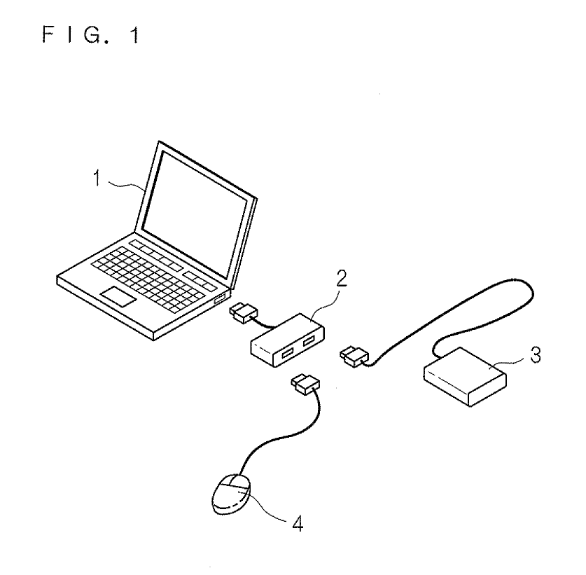

FIG. 1 is a conceptual view illustrating the appearance of the electronic equipment system according to Embodiment 1. The electronic equipment system of the present invention includes electronic equipment 1 such as a notebook PC or a game machine, a branching device (connection equipment) 2 for connection to the electronic equipment 1 to branch communication, a connection device 3 and a connection device 4 for connection to the branching device 2. The electronic equipment 1 uses USB 3.0. The branching device 2 corresponds to the connection equipment of the present invention, which internally divides signal lines used for USB 3.0 into signal lines used for USB 2.0 and signal lines not used for USB 2.0. The connection device 4 corresponds to a mouse, a keyboard or the like, which inputs/outputs data to/from the electronic equipment using USB 2.0. The connection device 3 corresponds to a HDD (Hard Disk Drive) or the like, which performs communication using signal lines not used for USB 2.0.

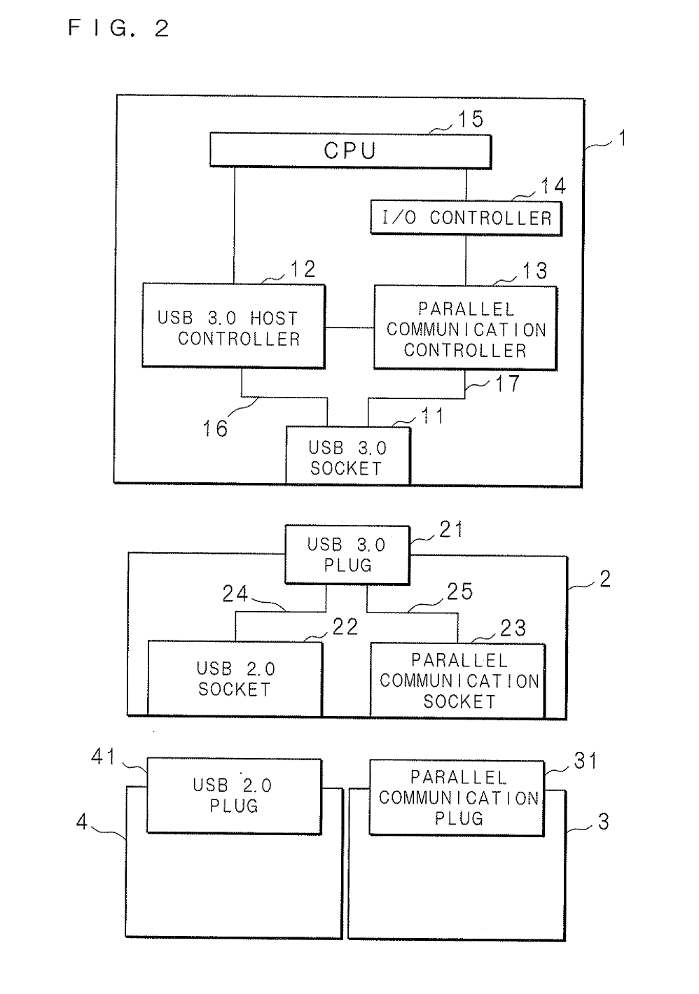

FIG. 2 is a block diagram illustrating the internal functional configuration of each of the equipment included in the electronic equipment system according to Embodiment 1. The electronic equipment 1 includes a USB 3.0 socket 11 which is the first connector for connecting the branching device 2 to the electronic equipment 1. The USB 3.0 socket 11 is a connector compatible with USB 3.0 which corresponds to the interface for inputting/outputting data (the first interface). The USB 3.0 has a backward compatibility with USB 2.0 which corresponds to another interface (the second interface). The USB 3.0 is an interface for inputting/outputting data using nine signal lines, whereas the USB 2.0 is an interface for inputting/outputting data using four of the nine signal lines. Four signal lines 16 used for USB 2.0 and five signal lines 17 not used for USB 2.0 are connected to the USB 3.0 socket 11. Both signal lines 16 and 17 are used for USB 3.0. For ease of illustration, each of the signal lines 16 and 17 are shown as one line in FIG. 2.

The four signal lines 16 used for USB 2.0 are connected to a USB 3.0 host controller 12. The USB 3.0 host controller 12 executes the processing of data input/output at the host side in accordance with a communication protocol for USB 2.0 and USB 3.0. The USB 3.0 host controller 12 is connected to a CPU (Central Processing Unit) 15 executing data processing required for the electronic equipment 1. The CPU 15 is connected to an I/O (Input/Output) controller 14, which controls input/output of data between various types of devices (not shown) in the electronic equipment 1 and CPU 15. The I/O controller 14 is, for example, an SATA (Serial Advanced Technology Attachment) controller. The I/O controller 14 is connected to various types of devices (not shown) such as a HDD or a keyboard.

The five signal lines 17 not used for USB 2.0 are connected to a parallel communication controller 13 which performs communication in parallel with USB 2.0. The parallel communication controller 13 is a processing circuit for executing processing on the host side in a communication using the signal lines 17 which are not used for USB 2.0. The parallel communication controller 13 is connected to the USB 3.0 host controller 12 and the I/O controller 14. The electronic equipment 1 is provided with various devices (not shown) such as a RAM (Random Access Memory) or a display, which executes various types of processing required for the electronic equipment 1.

The branching device 2 includes a USB 3.0 plug 21 which is the second connector for connection to the USB 3.0 socket 11. The USB 3.0 plug 21 is a connector compatible with USB 3.0 and is connected to nine signal lines. The nine signal lines connected to USB 3.0 plug 21 are divided into four signal lines 24 used for USB 2.0 and five signal lines 25 not used for USB 2.0. For ease of illustration, each of the signal lines 24 and 25 are shown as one line in FIG. 2. The signal lines 24 used for USB 2.0 is connected to USB 2.0 socket 22 which is the third connector compatible with USB 2.0. The signal lines 25 not used for USB 2.0 are connected to the parallel communication socket 23 which is the fourth connector. The parallel communication socket 23 is, for example, of the same shape as the USB 3.0 socket, and is not connected to the signal lines used for USB 2.0 The parallel communication socket 23 may alternatively have another shape.

The connection device 4 is provided with a USB 2.0 plug 41 for connection to the USB 2.0 socket. The connection device 4 further includes a processing circuit (not shown) for executing the processing of data input/output on the device side in accordance with the communication protocol of USB 2.0. The connection device 3 is provided with a parallel communication plug 31 for connection to the parallel communication socket 23. The connection device 3 further includes a processing circuit (not shown) for executing the processing on the device side in the communication using signal lines not used for USB 2.0.

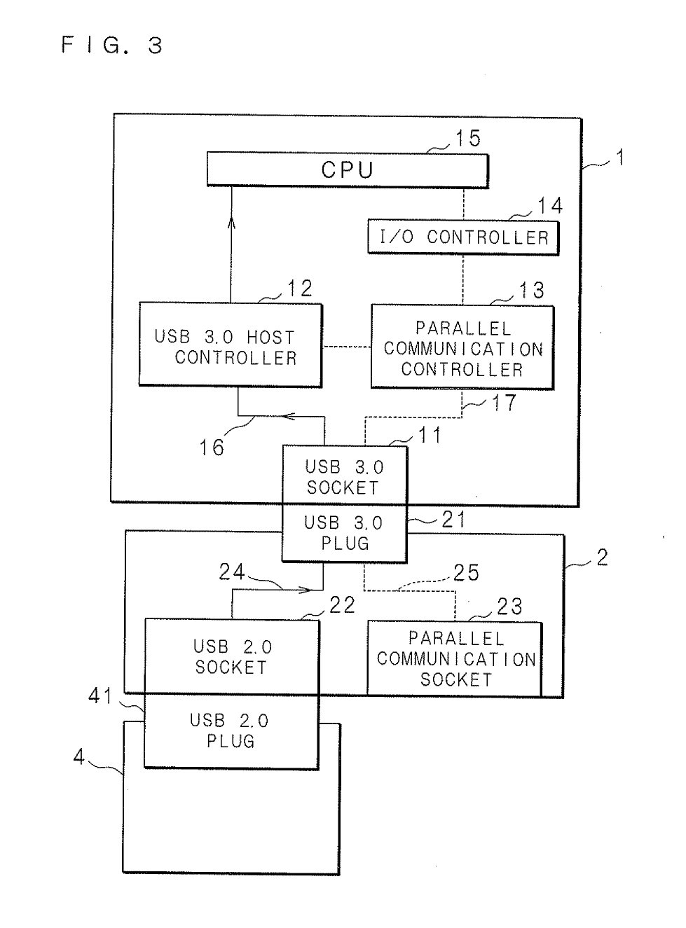

Next, the processing for input/output of data between the electronic equipment 1 and an external device will be described. FIG. 3 is a block diagram illustrating the state where the electronic equipment 1 inputs/outputs data in accordance with USB 2.0. In FIG. 3, signal lines not used for communication are indicated by a broken line. The USB 3.0 socket 11 is connected to the USB 3.0 plug 21 in the branching device 2. Moreover, the USB 2.0 socket 22 is connected to the USB 2.0 plug 41 in the connection device 4. To input data from the connection device 4 to the electronic equipment 1 in such a state, data is first passes through the USB 2.0 plug 41 and USB 2.0 socket 22 to be input from the connection device 4 to the branching device 2 in accordance with the communication protocol for USB 2.0. The data input to the branching device 2 then passes through the signal lines 24 to be input from the USB 2.0 socket 22 to the USB 3.0 plug 21, and is further input from the branching device 2 to the electronic equipment 1 through the USB 3.0 plug 21 and USB 3.0 socket 11.

The data input to the electronic equipment 1 is then input from the USB 3.0 socket 11 to the USB 3.0 host controller 12 through the signal lines 16. The USB 3.0 host controller 12 performs data processing on the input data in accordance with the communication protocol for USB 2.0 and then inputs the processed data to the CPU 15. To input data from the electronic equipment 1 to the connection device 4, the data is input in the order opposite to the above-described manner. As such, the USB 3.0 host controller 12 functions as the first input/output unit. Note that the electronic equipment 1 executes similar processing even in the case where a device which is compatible with USB 2.0 but not compatible with USB 3.0 is directly connected to the USB 3.0 socket 11.

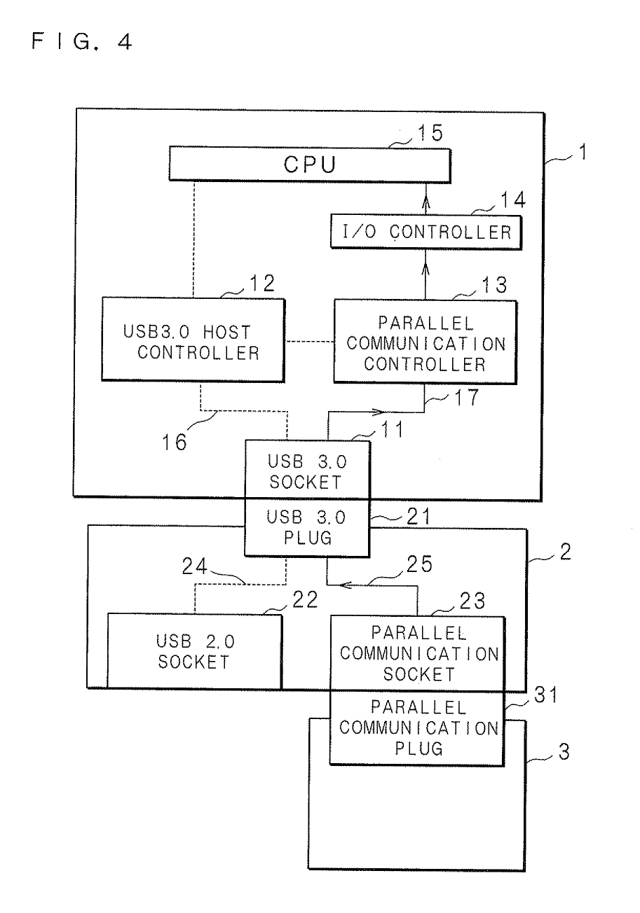

FIG. 4 is a block diagram illustrating the state where the electronic equipment 1 inputs/outputs data using signal lines not used for USB 2.0. In FIG. 4, the signal line not used for communication is indicated by a broken line. USB 3.0 socket 11 is connected to the USB 3.0 plug 21 in the branching unit 2. In addition, the parallel communication socket 23 is connected to the parallel communication plug 31 of the connection device 3. To input data from the connection device 3 to the electronic equipment 1 in such a state, the data is first input from the connection device 3 through the parallel communication plug 31 and parallel communication socket 23 to the branching device 2. The data input to the branching device 2 is further input to the USB 3.0 plug 21 from the parallel communication socket 23 through the signal lines 25 to the USB 3.0 plug 21, and then input from the branching device 2 to the electronic equipment 1 through the USB 3.0 plug 21 and USB 3.0 socket 11.

The data input to the electronic equipment 1 is input from the USB 3.0 socket 11 to the parallel communication controller 13 through the signal lines 17. The parallel communication controller 13 performs predetermined data processing on the input data for communication using signal lines not used for USB 2.0, and inputs the processed data to the I/O controller 14. The I/O controller 14 inputs data to the CPU 15. To input data from the electronic equipment 1 to the connection device 3, the data is input in the order opposite to the case described above. As such, the parallel communication controller 13 functions as the second input/output unit. The parallel communication controller 13 performs data processing for the CPU 15 to recognize that the connection device 3 is a device connected to the I/O controller 14.

The branching device 2 may be connected to the connection device 3 as well as the connection device 4 at the same time. In such as case, the USB 2.0 socket 22 is connected to the connection device 4, while the parallel communication socket 23 is connected to the connection device 3. Data is input/output through the route as illustrated in FIG. 3 when the data is input/output between the electronic equipment 1 and the connection device 4, whereas data is input/output through the route as illustrated in FIG. 4 when the data is input/output between the electronic equipment 1 and the connection device 3. Since the data input/output between the electronic equipment 1 and the connection device 4 has a communication route different from that for the data input/output between the electronic equipment 1 and the connection device 3, they can be executed in parallel. Moreover, communication between the electronic equipment 1 and connection device 3 using signal lines not used for USB 2.0 is performed at speed not affected by the communication for USB 2.0.

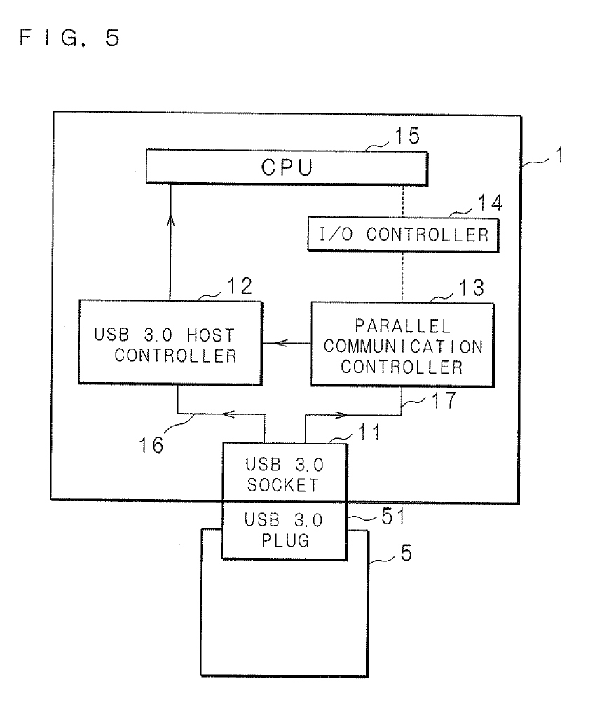

FIG. 5 is a block diagram illustrating the state where the electronic equipment inputs/outputs data in accordance with USB 3.0. In FIG. 5, signal lines not used in communication is indicated by a broken line. The USB 3.0 plug 51 included in the connection device 5 compliant with USB 3.0 is connected to the USB 3.0 socket 11. The connection device 5 includes a processing circuit (not shown) for executing the processing of data input/output on the device side in accordance with the communication protocol for USB 3.0. From the connection device 5, data is input through the USB 3.0 plug 51 and USB 3.0 socket 11 to the electronic equipment 1 in accordance with the communication protocol for USB 3.0.

The data input through the signal lines used for USB 2.0 among the data input to the electronic equipment 1 is further input to the USB 3.0 host controller 12 through the signal lines 16. The data input through the signal lines not used for USB 2.0 among the data input to the electronic equipment 1 is further input to the parallel communication controller 13 through the signal lines 17. The parallel communication controller 13 inputs the data in accordance with the input communication protocol for USB 3.0 to the USB 3.0 host controller 12. The USB 3.0 host controller 12 performs data processing on the input data in accordance with the communication protocol for USB 3.0, and inputs the processed data to the CPU 15. To input data from the electronic equipment 1 to the connection device, data is input in the order opposite to the above-described manner. In such a state where the connection device 5 compliant with USB 3.0 is connected, the USB 3.0 host controller 12 and parallel communication controller 13 function as the third input/output units, while the electronic equipment 1 inputs/outputs data to/from the connection device 5 in accordance with USB 3.0.

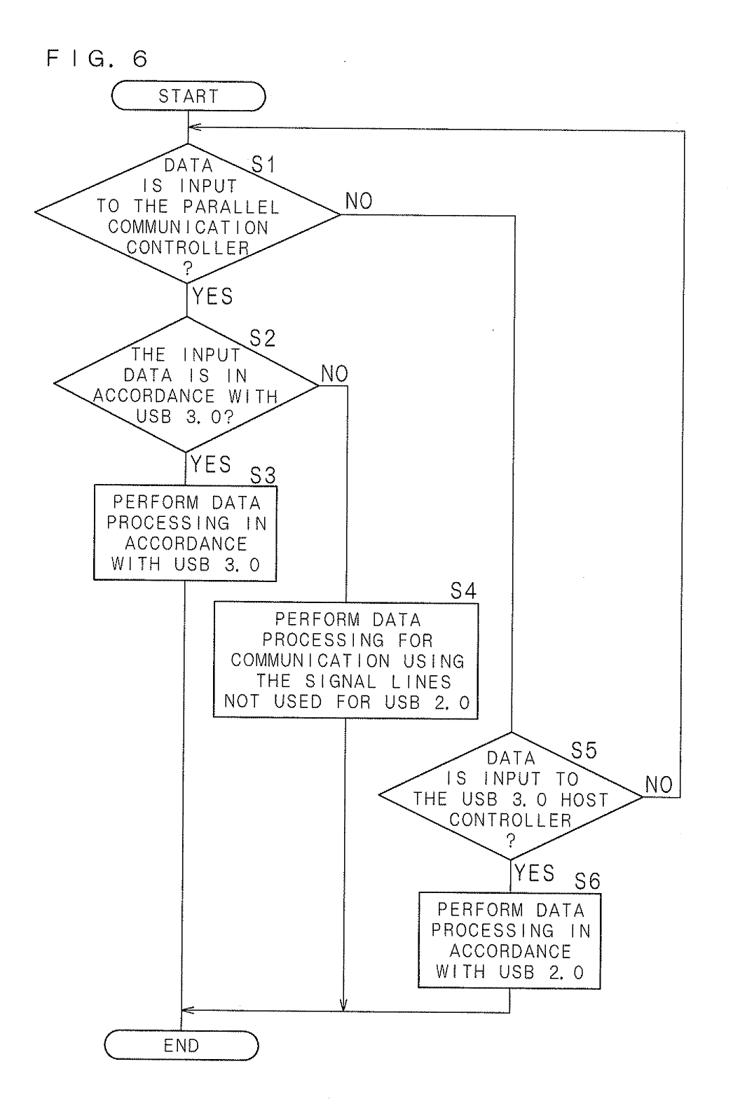

FIG. 6 is a flowchart illustrating a procedure of the processing executed by the electronic equipment 1 when data is input/output via the USB 3.0 socket 11. The parallel communication controller 13 continually awaits data input from the USB 3.0 socket 1, I/O controller 14 or USB host controller 12 (S1). When data is input to the parallel communication controller 13 (S1: YES), the parallel communication controller 13 determines whether or not the input data is in accordance with the communication protocol for USB 3.0 (S2). If the input data is in accordance with the communication protocol for USB 3.0 (S2: YES), the parallel communication controller 13 and USB 3.0 host controller 12 perform data processing for data input/output in accordance with USB 3.0 (S3).

If the data input at step S2 is not in accordance with the communication protocol for USB 3.0 (S2: NO), the parallel communication controller 13 performs predetermined data processing for communication using the signal lines not used for USB 2.0 (S4).

If data is not input to the parallel communication controller 13 (S1: NO), the USB 3.0 host controller 12 awaits data input, which is in accordance with the communication protocol for USB 2.0, from the USB 3.0 socket 11 or CPU 15 (S5). If the data is not input (S5: NO), the electronic equipment 1 returns the processing back to step S1. If the data is input (S5: YES), the USB 3.0 host controller 12 performs data processing for data input/output in accordance with USB 2.0 (S6). After steps S3, S4 or S6 are completed, the electronic equipment 1 terminates the processing and repeats the processing from step S1. It is noted that the processing at the USB 3.0 host controller 12 and parallel communication controller 13 may be executed by software.

As specifically described above, the electronic equipment system according to the present embodiment includes the branching device 2 connected to the USB 3.0 socket 11 of the electronic equipment 1, which divides the signal lines used for USB 3.0 into the signal lines used for USB 2.0 and the signal lines not used for USB 2.0. The branching device 2 may be connected to the connection device 4 for performing communication in accordance with USB 2.0 and to the connection device 3 for performing communication using the signal lines not used for USB 2.0. The electronic equipment 1 inputs/outputs data to/from the connection device 4 through the branching device 2 in accordance with USB 2.0, and inputs/outputs data to/from the connection device 3 through the branching device 2 by communication using the signal lines not used for USB 2.0. Since the data input/output between the electronic equipment 1 and the connection device 4 has a communication route different from that for the data input/output between the electronic equipment 1 and the connection device 3, they can be executed in parallel. The electronic equipment 1 can, therefore, input/output data to/from the connection device 3 using the signal lines not used for USB 2.0 even when it is connected to another connection device 4 performing communication in accordance with USB 2.0. Thus, the electronic equipment 1 can sufficiently make use of its high signal processing capability.

Moreover, since the branching device 2 has a structure in which the signal lines for USB 3.0 is divided into the signal lines used for USB 2.0 and the signal lines not used for USB 2.0, the manufacturing cost can be reduced compared to a USB hub which requires a switching function or the like. The present invention can, therefore, realize the electronic equipment system at a low cost, in that the connection device 3 and connection device 4 can input/output data in parallel to/from the electronic equipment 1 including USB 3.0 socket 11.

### Embodiment 2

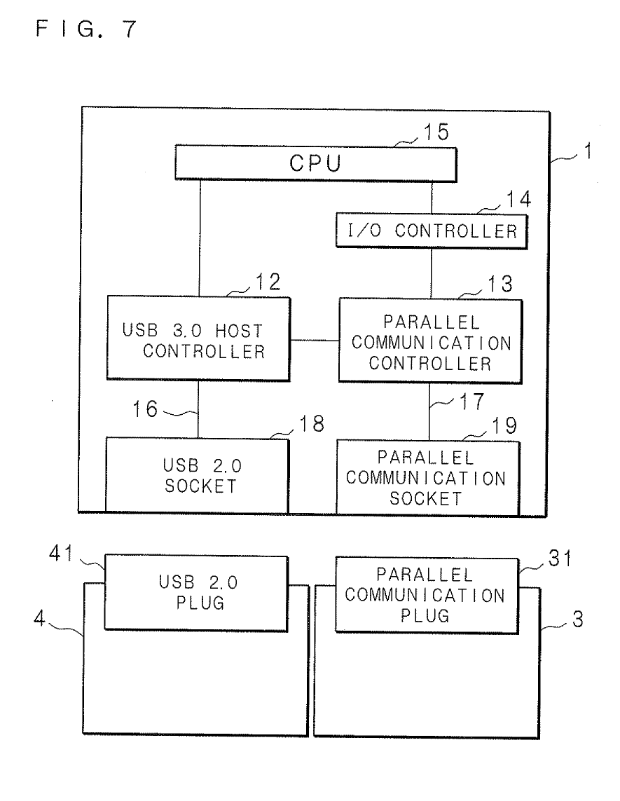

FIG. 7 is a block diagram illustrating the internal functional configuration of each of the equipment included in the electronic equipment system according to Embodiment 2. The electronic equipment 1 includes a USB 2.0 socket (fifth connector) 18 which is a connector for connecting an external device thereto. The USB 2.0 socket 18 is connected to the USB 3.0 host controller 12 by the signal lines 16. Moreover, the electronic equipment 1 includes a parallel communication socket (sixth connector) 19 for performing communication using the signal lines 17 not used for USB 2.0 instead of using the signal lines used for USB 2.0 among the signal lines for USB 3.0. The parallel communication socket 19 is connected to the parallel communication controller 13 by the signal lines 17.

The USB 2.0 socket 18 can be connected to the connection device 4 provided with the USB 2.0 plug 41. In the state where the connection device 4 is connected to the USB 2.0 socket 18, data is input from the connection device 4 to the electronic equipment 1 through the USB 2.0 plug 41 and USB 2.0 socket 18 in accordance with the communication protocol for USB 2.0. The data input to the electronic equipment 1 is further input from the USB 2.0 socket 18 to the USB 3.0 host controller 12 through the signal lines 16. The USB 3.0 host controller 12 performs data processing on the input data in accordance with the communication protocol for USB 2.0, and inputs the processed data to the CPU 15. In order to input data from the electronic equipment 1 to the connection device 4, the data is input in the order opposite to the above-described manner. Accordingly, the USB 3.0 host controller 12 functions as the fourth input/output unit.

Furthermore, the parallel communication socket 19 can be connected to the connection device 3 provided with the parallel communication plug 31. In the state where the connection device 3 is connected to the parallel communication socket 19, data is input from the connection device 3 to the electronic equipment 1 through the parallel communication plug 31 and parallel communication socket 19. The data input to the electronic equipment 1 is further input from the parallel communication socket 19 to the parallel communication controller 13 through the signal lines 17. The parallel communication controller 13 performs predetermined data processing for communication using the signal lines not used for USB 2.0, and the processed data is input to the I/O controller 14. The I/O controller 14 inputs data to the CPU 15. To input data from the electronic equipment 1 to the connection device 3, data is input in the order opposite to the above-described manner. Accordingly, the parallel communication controller 13 functions as the fifth input/output unit.

The electronic equipment 1 can also be connected to the connection device 3 and to the connection device 4 at the same time. The USB 2.0 socket 18 is connected to the connection device 4, while the parallel communication socket 19 is connected to the connection device 3. Data is then input/output between the electronic equipment 1 and the connection device 3 or connection device 4.

As specifically described above, in the electronic equipment system according to the present embodiment, the signal lines for USB 3.0 is divided into the signal lines 16 used for USB 2.0 and the signal lines 17 not used for USB 2.0, each of which can be connected to a connection device outside the electronic equipment 1. The electronic equipment 1 inputs/outputs data to/from the connection device 4 in accordance with USB 2.0, and to/from the connection device 3 by communication using the signal lines not used for USB 2.0. Since the data input/output between the electronic equipment 1 and the connection device 4 has a communication route different from that for the data input/output between the electronic equipment 1 and the connection device 3, they can be executed in parallel. The electronic equipment 1 can, therefore, input/output data to/from the connection device 3 using the signal lines not used for USB 2.0 even when it is connected to another connection device 4 performing communication in accordance with USB 2.0. Thus, the electronic equipment 1 can sufficiently make use of its high signal processing capability.

### Embodiment 3

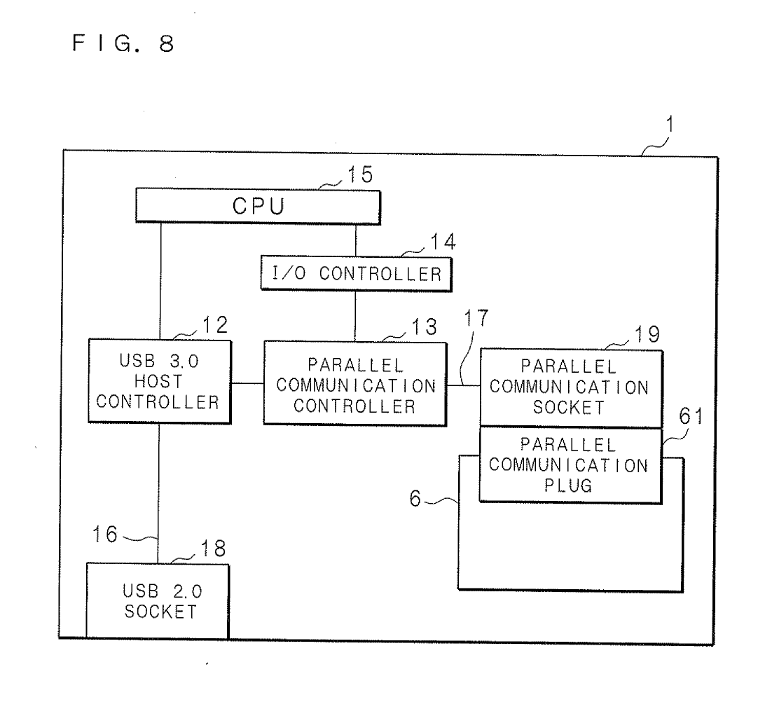

FIG. 8 is a block diagram illustrating the internal functional configuration of each of the equipment included in the electronic equipment system according to Embodiment 3. In Embodiment 3, the parallel communication socket 19 included in the electronic equipment 1 is a connector for connection to a device arranged inside the electronic equipment 1. The electronic equipment 1 includes an internal device 6 having a parallel communication plug 61, the internal device 6 being connected to the parallel communication socket 19 by the parallel communication plug 61. The internal device 6 is, for example, a HDD. As the other configuration parts in the electronic equipment system are similar to those in Embodiment 2, corresponding parts are denoted by the same reference codes and will not be described here.

In the state where the USB 2.0 socket 18 is connected to the connection device 4, the electronic equipment 1 and connection device 4 input/output data by processing similar to that in Embodiment 2. Moreover, the data from the internal device 6 passes through the parallel communication plug 61 and parallel communication socket 19, and then is input to the parallel communication controller 13 through the signal lines 17. The parallel communication controller 13 performs predetermined data processing on the input data for communication using the signal lines not used for USB 2.0 and inputs the processed data to the I/O controller 14. The I/O controller 14 inputs data to the CPU 15. To input data from CPU 15 to the internal device 6, data is input in the order opposite to the above-described manner.

As has been described above, in the electronic equipment system according to the present embodiment, the signal lines 16 used for USB 2.0 can be connected to the connection device 4 outside the electronic equipment 1, while the signal lines 17 not used for USB 2.0 is connected to the internal device 6 in the electronic equipment 1. The electronic equipment 1 inputs/outputs data to/from the external connection device 4 in accordance with USB 2.0, whereas it inputs/outputs data to/from the internal device 6 by communication using the signal lines not used for USB 2.0. Since the data input/output between the electronic equipment 1 and the connection device 4 has a communication route different from that of the data input/output for the internal device 6, they can be executed in parallel. Hence, the electronic equipment 1 inputs/outputs data to/from the internal device 6 using the signal lines not used for USB 2.0 even in the case where the connection device 4 performing communication in accordance with USB 2.0 is connected thereto. This allows the electronic equipment 1 to sufficiently make use of its high signal processing capability.

Note that the electronic equipment 1 may have a form in which another interface is interposed between the parallel communication socket 19 and an internal device. For example, the electronic equipment 1 may have such a configuration that an interface for converting communication using the signal lines not used for USB 2.0 into communication in accordance with SATA is connected to the parallel communication socket 19, while a device compliant with SATA is connected to the interface.

While Embodiments 1 to 3 described above illustrates the cases where the second interface of the present invention corresponds to USB 2.0 and the first interface corresponds to USB 3.0, they are not limited thereto. The present invention may alternatively use an interface other than USB 2.0 or USB 3.0. Furthermore, though Embodiments 1 to 3 illustrate that the electronic equipment 1 corresponds to PC, it may alternatively be equipment other than PC, such as a game machine. As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An electronic equipment system, comprising:
electronic equipment; and
connection equipment for connection to the electronic equipment,
wherein the electronic equipment includes
a first connector compliant with a first interface for inputting/outputting data through a plurality of signal lines including signal lines used for a second interface for inputting/outputting data, and
the connection equipment includes:
a second connector for connection to the first connector;
a third connector connected to the second connector by signal lines used for the second interface among the plurality of signal lines used for the first interface, but not connected to the second connector by signal lines not used for the second interface; and
a fourth connector not connected to the second connector by the signal lines used for the second interface among the plurality of signal lines used for the first interface, but connected to the second connector by the signal lines not used for the second interface.

2. The electronic equipment system according to claim 1,
wherein the connection equipment relays input/output of data between a device compliant with the second interface and the electronic equipment through signal lines connected to the third connector when the second connector is connected to the first connector and the device is connected to the third connector, and relays input/output of data between a device and the electronic equipment through signal lines connected to the fourth connector when the second connector is connected to the first connector and the device is connected to the fourth connector.

3. The electronic equipment system according to claim 2, wherein the electronic equipment further includes:
a first input/output unit for inputting/outputting data in accordance with the second interface through the first connecter in a state where the connection equipment is connected to the first connector;
a second input/output unit for inputting/outputting data through the first connector by signal lines not used for the second interface, not by signal lines used for the second interface among the plurality of signal lines used for the first interface in a state where the connection equipment is connected to the first connector; and
a third input/output unit for inputting/outputting data in accordance with the first interface through the first connector when a device compliant with the first interface is connected to the first connector.

4. Electronic equipment, comprising:
a first connector compliant with a first interface for inputting/outputting data through a plurality of signal lines including signal lines used for a second interface for inputting/outputting data;
a first input/output unit for inputting/outputting data in accordance with the second interface through the first connector;
a second input/output unit for inputting/outputting data through the first connector by signal lines not used for the second interface, not by signal lines used for the second interface among the plurality of signal lines used for the first interface; and
a third input/output unit for inputting/outputting data in accordance with the first interface through the first connector.

5. Electronic equipment, comprising:
a fifth connector compliant with a second interface for inputting/outputting data through signal lines;
a fourth input/output unit for inputting/outputting data in accordance with the second interface through the fifth connector;
a sixth connector not connected to signal lines used for the second interface among a plurality of signal lines used for a first interface for inputting/outputting data through the plurality of signal lines including signal lines used for the second interface, but connected to signal lines not used for the second interface; and
a fifth input/output unit for inputting/outputting data by the signal lines through the sixth connector.

6. Connection equipment used for connection to an electronic equipment, comprising:
a second connector for connection to a first connector of an electronic equipment compliant with a first interface for inputting/outputting data through a plurality of signal lines including signal lines used for a second interface for inputting/outputting data through signal lines;
a third connector connected to the second connector by signal lines used for the second interface among the plurality of signal lines used for the first interface, but not connected to the second connector by signal lines not used for the second interface; and
a fourth connector not connected to the second connector by the signal lines used for the second interface, but connected to the second connector by the signal lines not used for the second interface among the plurality of signal lines used for the first interface.
